(19) United States
(12) Patent Application Publication
(10) Pub. No.: US 2024/0233974 A9
(43) Pub. Date: Jul. 11, 2024

(54) PRODUCTION OF RADIOISOTOPES WITH HIGHLY ENRICHED TARGET ENCLOSURE MATERIAL

(71) Applicant: Westinghouse Electric Company LLC, Cranberry Township, PA (US)

(72) Inventors: Caroline E. CURRAN, McMurray, PA (US); Michael C. PRIBLE, Cranberry Twp, PA (US); Michael D. HEIBEL, Broomfield, CO (US)

(73) Assignee: Westinghouse Electric Company LLC, Cranberry Township, PA (US)

(21) Appl. No.: 18/049,343

(22) Filed: Oct. 25, 2022

(51) Int. Cl. G21G 1/06; G21G 1/00

(52) U.S. Cl. CPC G21G 1/06; G21G 1/0005

(57) ABSTRACT

An enclosure for producing a radioisotope from an irradiation target material in a thimble guide tube of a nuclear reactor core is provided. The enclosure is comprised of an enriched material and defines a cavity therein. The cavity of the enclosure is configured to house the irradiation target material. A target assembly for producing synthetic radioisotopes and a method for producing pharmaceutical radioisotopes with a target assembly are also provided.

### BACKGROUND

The production of pharmaceutical radioisotopes entails inserting an irradiation target material into an enclosure and irradiating the enclosure with a neutron flux for a specified irradiation cycle time. However, currently available enclosures can require extended periods of storage in spent fuel pools before the target carrier components and any target materials housed therein can be safely handled and/or transported elsewhere for processing/disposal. Issues related to safety and transportation logistics can contribute to the cost of producing pharmaceutical radioisotopes and limit access to radiotherapy treatments. A need exists to produce the desired radioisotopes without also requiring extended periods of downtime following the irradiation.

### SUMMARY

The following summary is provided to facilitate an understanding of some of the innovative features unique to the aspects disclosed herein, and is not intended to be a full description. A full appreciation of the various aspects disclosed herein can be gained by taking the entire specification, claims, and abstract as a whole.

In various aspects, an enclosure for producing a radioisotope from an irradiation target material in a thimble guide tube of a nuclear reactor core is disclosed. In some aspects, the enclosure is comprised of an enriched material and defines a cavity therein. In other aspects, the cavity of the enclosure is configured to house the irradiation target material.

In various aspects, a target assembly for producing synthetic isotopes is disclosed. In some aspects, the target assembly includes an enclosure defining a cavity therein; and an irradiation target material positioned within the cavity of the enclosure. In certain aspects, the enclosure includes an outer wall comprised of an enriched material. In other aspects, the irradiation target material comprises a precursor to a first radioisotope.

In various aspects, a method for producing pharmaceutical radioisotopes with a target assembly is disclosed. In some aspects, the method includes inserting the target assembly into a thimble guide tube; irradiating the target assembly with a neutron flux; and removing the irradiated target assembly from the thimble guide tube to produce one or more pharmaceutical radioisotopes. In certain aspects the target assembly includes an enclosure and at least one irradiation target material positioned within the enclosure. In other aspects, the enclosure is comprised of an enriched material.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of any of the aspects disclosed herein.

### BRIEF DESCRIPTION OF THE DRAWINGS

The various aspects described herein, together with objects and advantages thereof, may best be understood by reference to the following description, taken in conjunction with the accompanying drawings as follows.

FIG. 1 is a partial cross-section view of a nuclear reactor core, in accordance with at least one non-limiting aspect of the present disclosure.

FIG. 2 is a cross-sectional schematic representation of an enclosure, in accordance with at least one non-limiting aspect of the present disclosure.

FIG. 3 illustrates results of an irradiation of an enriched material indicating a change in activity level, in accordance with at least one non-limiting aspect of the present disclosure.

FIG. 4 illustrates results of an irradiation of an enriched material indicating a change in activity level, in accordance with at least one non-limiting aspect of the present disclosure.

FIG. 5 illustrates results of an irradiation of an enriched material indicating a change in activity level, in accordance with at least one non-limiting aspect of the present disclosure.

Corresponding reference characters indicate corresponding parts throughout the several views. The exemplifications set out herein illustrate various aspects of the present disclosure, in one form, and such exemplifications are not to be construed as limiting the scope of any of the aspects disclosed herein.

### DETAILED DESCRIPTION

Certain exemplary aspects of the present disclosure will now be described to provide an overall understanding of the principles of the composition, function, manufacture, and use of the compositions and methods disclosed herein. An example or examples of these aspects are illustrated in the accompanying drawings. Those of ordinary skill in the art will understand that the compositions, articles, and methods specifically described herein and illustrated in the accompanying drawing are non-limiting exemplary aspects of the present disclosure. The features illustrated or described in connection with one exemplary aspect may be combined with the features of other aspects. Such modifications and variations are intended to be included within the scope of the present disclosure.

Reference throughout the specification to “various examples,” “some examples,” “one example,” “an example,” or the like, means that a particular feature, structure, or characteristic described in connection with the example is included in an example. Thus, appearances of the phrases “in various examples,” “in some examples,” “in one example,” “in an example,” or the like, in places throughout the specification are not necessarily all referring to the same example. Furthermore, the particular features, structures, or characteristics may be combined in any suitable manner in an example or examples. Thus, the particular features, structures, or characteristics illustrated or described in connection with one example may be combined, in whole or in part, with the features, structures, or characteristics of another example or other examples without limitation. Such modifications and variations are intended to be included within the scope of the present examples.

In the following description, like reference characters designate like or corresponding parts throughout the several views of the drawings. Also in the following description, it is to be understood that such terms as “forward,” “rearward,” “left,” “right,” “above,” “below,” “upwardly,” “downwardly,” and the like are words of convenience and are not to be construed as limiting terms.

The term “enriched material” is used herein with reference to a material, prior to exposure to any significant radiation sources, that is comprised of at least one stable isotope at an amount greater than a typical naturally occurring amount. The term “isotopically pure” is used herein with reference to an enriched material comprising a single isotope at a level greater than 98 mol %, or greater than 99 mol %, or greater than 99.99 mol %, or of about 100 mol %. The term “inert material” is used herein with reference to a material that does not participate in a chemical reaction and/or a nuclear reaction in the environment of a nuclear reactor or an auxiliary neutron generator.

Reference throughout the specification to terms “short half-life” and “short-lived radioisotope” are made with reference to half-lives on the order of days. Reference throughout the specification to terms “relatively long half-life” and “long-lived radioisotopes” are made with reference to half-lives on the order of weeks, or on the order of months, or on the order of years.

Pharmaceutical radioisotopes can be synthetically produced by irradiating and/or bombarding an irradiation target material with a constant neutron flux for a specified irradiation period. For example, pharmaceutically useful Lutetium-177 is a beta-emitter having a relatively short half-life of about 6.7 days. Lutetium-177 can be produced by bombarding an Ytterbium-176 based target material with a neutron flux of about 5×10¹³ neutrons/cm²-s for an irradiation period of at least 4 days. Other pharmaceutical radioisotopes of interest may also be produced with neutron irradiation, such as, for example, Actinium-225. Upon undergoing an irradiation, a compound, such as, for example, a water soluble salt, comprising the pharmaceutical radioisotope may be incorporated into a suspension and/or a solution in preparation for an administration thereof.

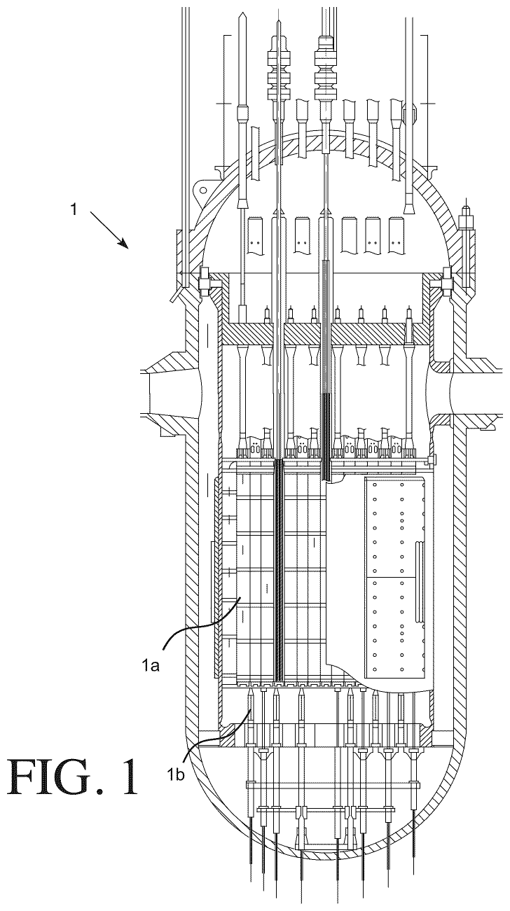

In the context of a neutron activation process, an irradiation target material is housed within an enclosure to form a target assembly and the target assembly is exposed to and/or removed from a neutron rich environment to provide a desired neutron dose thereto. For example, FIG. 1 provides a cross-section view of a nuclear reactor core 1 containing a fuel assembly 1a, in accordance with at least one non-limiting aspect of the present disclosure. The fuel assembly 1a can provide a neutron flux directed into a tubular guide thimble positioned therein. The inner volume of the guide thimble can be accessed through a bottom penetration 1b. During operation of the nuclear reactor core 1, a target assembly can be inserted into the bottom penetration 1b to position the target assembly within the guide thimble of the fuel assembly 1a to expose the target assembly to a neutron-rich environment, thereby providing a neutron flux to the irradiation target material housed within the enclosure to produce a radioisotope of interest. When a desired irradiation period has elapsed and/or the irradiation target material has captured a desired neutron dose, the irradiated target assembly is retracted from the guide thimble and processed thereafter to extract the desired radioisotope of the irradiation target material from the enclosure.

Currently available enclosures can be made from materials found in nuclear reactor components, such as, for example, 304L stainless steel, 316L stainless steel, and Inconel 718. However, exposing these material compositions of currently available enclosures to neutron rich environments can form radioisotopes having relatively long half-lives, such as, for example, on the order of at least a year. As a result, these irradiated enclosures can require extended periods of submerged storage in pools prior to reaching lower and/or safer activity levels safe enough for operators to handle. Thus, the use of currently available enclosures for housing target materials can present safety hazards to operators and their environment, thereby complicating the logistics of shipping, handling and/or reusing the irradiated enclosures. Moreover, the extended storage times required for these irradiated enclosures can present resource allocation issues due to competing radiation sources requiring storage such as, for example, spent fuel assemblies. Accordingly, various aspects of the present disclosure provide various methods and devices for irradiating target materials without producing any undesired long-lived radioisotopes, thereby avoiding logistical issues associated with producing synthetic radioisotopes.

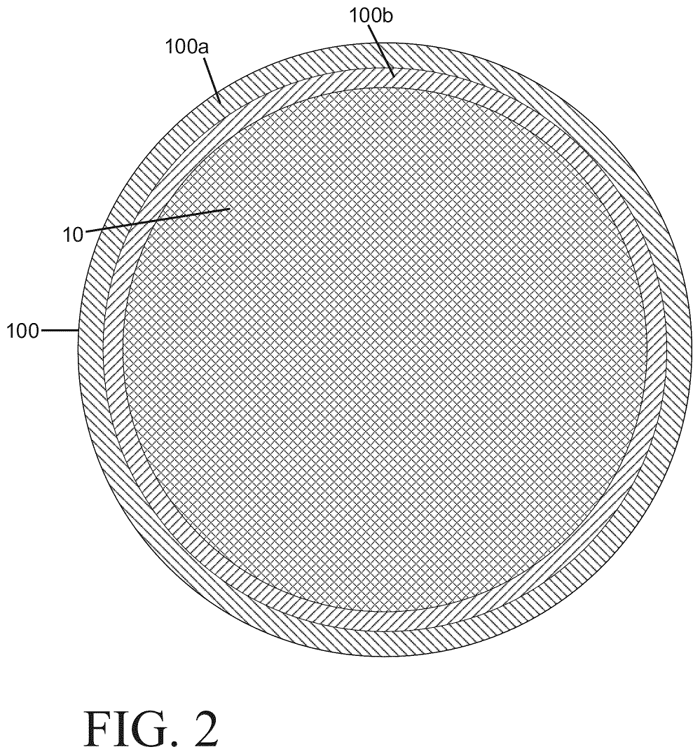

Now referring to FIG. 2, a cross-section view of an enclosure 100 for producing a radioisotope from an irradiation target material 10 in a thimble guide tube of a nuclear reactor core is provided, in accordance with at least one non-limiting aspect of the present disclosure. In some examples, the outer cross-section geometry of the enclosure 100 can be substantially the same as, or slightly smaller than, the inner diameter of a thimble guide tube of a nuclear reactor core. For example, the enclosure 100 can be configured with a substantially cylindrical tubular geometry having an outer diameter of about 0.3 inches, or about 0.25 inches, or about 0.2 inches, or about 0.15 inches. In certain examples, the enclosure 100 includes an outer wall 100a having an outer diameter and an inner diameter. The enclosure 100 can optionally include an inner layer 100b having an outer diameter and an inner diameter. Other configurations of the enclosure 100 are contemplated by the present disclosure. For example, in some implementations, the outer cross-section geometry of the enclosure 100 can be configured as a hexagonal geometry, a rectangular geometry, or any other closed polygonal geometry.

In various examples, the enclosure 100 defines a cavity therein. The cavity of the enclosure 100 is configured to house an irradiation target material 10. For example, if the irradiation target material 10 is in the form of a cylindrical slug, the cavity can be configured with a cylindrical cross-section geometry substantially the same as, or slightly larger than, the cylindrical slug. In some examples, the inner diameter of the outer wall 100a defines the cross-section geometry of the cavity. In examples of the enclosure 100 including the optional inner layer 100b, the inner diameter of the inner layer 100b defines the cross-section geometry of the cavity.

In various examples, the enclosure 100 is comprised of an enriched material. In some examples, the enriched material can include a precursor to a short-lived neutron-activated radioisotope having a half-life of less than one week, or less than 5 days, or less than 1 day. In certain examples, the enclosure 100 can be configured to have a short half-life upon exposure to a neutron flux. For example, the portion of the enclosure 100 materials susceptible to neutron capture can be limited to precursors of short-lived radioisotopes. An enclosure 100 incorporating this configuration can provide an advantage of minimized downtime prior to shipping and/or handling following a period of irradiation with a neutron flux, such as, for example, a duration of time required to produce a medically useful radioisotope with a constant neutron flux, without compromising operator and/or environmental safety. In certain examples, the outer wall 100a of the enclosure 100 can be comprised of the enriched material.

Additionally, the material properties of the enclosure 100 can be configured to reliably house an irradiation target. For example, an outer wall 100a of the enclosure 100 can include the enriched material in combination with chemically separable alloying materials to optimize a mechanical property, such as, for example, strength and/or toughness, and/or a chemical property, such as, for example, corrosion resistance. This configuration is particularly advantageous for prolonging the life of an enclosure 100 in the event that an enclosure 100 is inadvertently exposed to external stresses or if the enclosure 100 is intended to be reused. In some examples, the enclosure 100 comprises alloying materials that are precursors to short-lived radioisotopes. In certain examples, the enclosure 100 is comprised of specific isotopes of alloying materials such as, for example, specific isotopes of Copper and/or Nickel. Thus, the composition of the enclosure 100 can be configured to provide the advantages of having a shorter half-life upon irradiation without compromising the structural integrity of the enclosure 100 required to reliably house an irradiation target material 10, thereby avoiding the safety, logistical and/or economic issues associated with employing conventional irradiation target assemblies for producing synthetic radioisotopes.

The enriched material can be configured as an isotopically pure material. For example, the enriched material can be configured as a precursor to a specific beta-emitting radioisotope with a known half-life. In some examples, the enclosure 100 can include isotopically pure enriched Nickel and/or Copper. In certain examples, the enclosure 100 can include Nickel-64, Copper-63 or Copper-65. Other configurations are contemplated by the present disclosure. For example, in some implementations, the enriched material can be configured as a precursor to an alpha-emitting radioisotope, such as, for example, an isotope of Lead, Thallium and/or Bismuth.

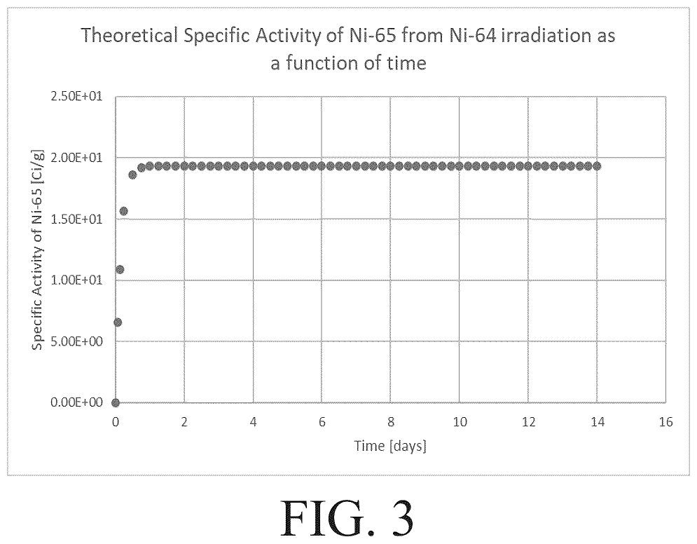

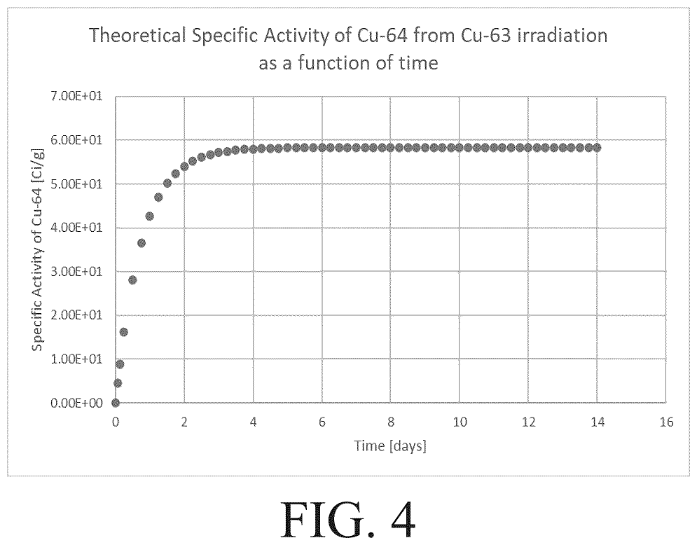

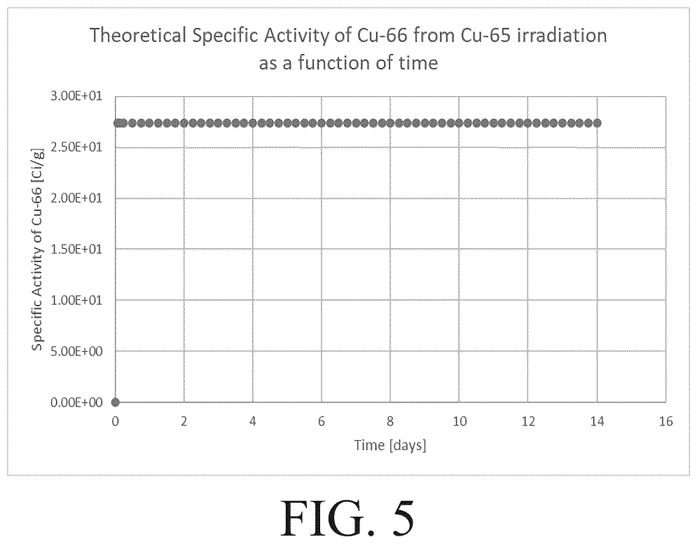

Since an isotopically pure enriched material does not contain more than one isotope of a given element, an irradiation thereof with a constant neutron flux can produce a specific radioisotope of the given element with a defined activity level and/or decay mode. For example, irradiating an enclosure 100 comprising a Copper-65 based enriched material will form Copper-66 which undergoes β⁻ decay with a half-life of less than 1 hour. With respect to specific activity, each of FIGS. 3-5 independently illustrate the theoretical specific activity of Nickel-65, Copper-64 and Copper-66 in Curies/g from irradiating Nickel-64, Copper-63 or Copper-65, respectively, as a function of time. Thus, the composition of an enclosure 100 can be configured to provide a predictable decay behavior, thereby facilitating an optimization of the logistical operations associated with handling an irradiation target assembly following an irradiation thereof.

Since Copper-64, Copper 66, and Nickel-65 are emerging in the market as effective radiopharmaceuticals for cancer treatments, an enclosure 100 comprised of Copper-63, Copper-65, or Nickel-64 can itself provide a source of a medical radioisotope upon irradiation with a neutron flux while simultaneously providing a housing for an irradiation target material 10 of interest. When an enclosure 100 incorporating one of these enriched materials is employed in a production of Lutetium-177, the activated form of the enriched material can be produced within the timeframe of an irradiation period associated with producing Lutetium-177 to provide a second pharmaceutical radioisotope having a significant activity level. For example, as shown in FIGS. 3-5, a maximum theoretical specific activity of a radioisotope produced from irradiating Nickel-64, Copper-63 or Copper-65 can be achieved with an irradiation thereof under a constant neutron flux of 5×10¹³ neutrons/cm²-s for an irradiation period of about 4 days, or for about 1 days, or less than 1 day. Thus, an enclosure 100 comprising Nickel-64, Copper-63 or Copper-65 can be incorporated into a process for producing Lutetium-177 to produce increased amounts and/or varieties of medical radioisotopes over processes employing conventional enclosures without requiring any significant process parameter modifications thereof.

The present disclosure also provides a target assembly for producing synthetic radioisotopes. The target assembly includes an enclosure and an irradiation target material positioned within a cavity of the enclosure. The enclosure of the target assembly is similar in many respects to other enclosures described elsewhere in the present disclosure, which are not repeated herein at the same level of detail for brevity. In various examples, the enclosure includes an outer wall comprised of an enriched material. In some examples, the enclosure can be comprised of an alloy of an enriched material. In certain examples, the enclosure can include a number of layers surrounding the cavity. The enclosure of the target assembly can be configured similarly to an enclosure 100 as described hereinabove. Thus, the enclosure of the target assembly can be configured to reliably house an irradiation target material and to be inserted into a thimble guide tube of an operating nuclear reactor core without becoming a long-lived radioisotope. Additionally, the enriched material of the enclosure can be configured as an isotopically pure material to provide a predictable decay behavior following an irradiation period. For example, the enriched material can be based on Nickel-64, Copper-63, and/or Copper-65. Thus, the enclosure of the target assembly can be configured to provide a minimized and/or optimized time between irradiation and handling of the irradiated target assembly without suffering from safety and logistics issues associated with conventional enclosures following an irradiation thereof.

In various examples, the irradiation target material of the target assembly includes a precursor to a first radioisotope and the cavity is configured to surround the irradiation target material. The first radioisotope can be configured as a short-lived radioisotope and/or a medical radioisotope. For example, the irradiation target material can comprise a precursor to Lutetium-177 and/or Actinium-225. In certain examples, the irradiation target material can be configured as one or more slugs having a cross-sectional geometry smaller than, or substantially the same as, an inner cavity defined by the enclosure. In the slug configuration of the irradiation target material, the length of each slug can be sized to be less than half of the length of an inner cavity defined by the enclosure. Thus, more than one irradiation target material incorporating this configuration can be positioned within the enclosure. Accordingly, an irradiation target material including a precursor to Lutetium-177 and/or Actinium-225 can be housed in an enclosure comprised of Nickel-64, Copper-63, and/or Copper-65 to provide multiple pharmaceutical radioisotope product streams in a process for producing synthetic radioisotopes without requiring multiple irradiation cycles and/or multiple target assemblies.

In some examples, the irradiation target material and the enriched material of the enclosure can be separated by a layer of inert material. The layer of inert material can provide a barrier to physical and/or chemical interactions between an irradiation target material and the enclosure, thereby facilitating a separation thereof in any post-processing following irradiation. Since synthetic radioisotopes begin to decay in the absence of an appropriate radiation source, any delays after the retraction of the target assembly in a neutron activation process can result in a lower activity level of the desired radioisotope upon arriving at a final point of destination, especially in the case of short-lived pharmaceutical radioisotopes. Thus, a target assembly configured with the layer of inert material can optimize the deliverable activity level of a pharmaceutical radioisotope and/or reduce the time required to prepare a shipment thereof by maintaining a boundary between the irradiation target material and the enclosure during an irradiation cycle.

As described herein, the target assembly including an irradiation target material and an enclosure comprised of an enriched material can be incorporated into a radioisotope production method. For example, a method for producing pharmaceutical radioisotopes can include inserting the target assembly into a thimble guide tube, irradiating the target assembly with a neutron flux, and retracting the irradiated target assembly from the thimble guide tube to produce one or more medical radioisotopes. In some examples, the enriched material prior to irradiation can include Nickel-64, Copper-63, and/or Copper-65. In certain examples, the irradiated target material comprises Lutetium 177 and/or Actinium-225. In one example, the method comprises transporting the one or more pharmaceutical radioisotopes within 1 week, or 5 days, or 3 days, or 2 days, or 1 day or on the same day following the retraction of the target assembly. The radioisotope production method can optionally comprise post-processing of the target assembly after a retraction thereof. For example, the one or more pharmaceutical radioisotopes can undergo a chemical process and/or a mechanical separation to facilitate a transportation or an administration thereof.

As discussed elsewhere in the present disclosure, the target assembly can be configured with various combinations of irradiation target materials and enriched materials to provide multiple product streams and/or enclosures with short half-lives in a process for producing synthetic radioisotopes. Thus, the irradiated target material and/or the irradiated enclosure of the target assembly employed in a pharmaceutical radioisotope production can independently be comprised of one or more pharmaceutical radioisotopes upon an irradiation and/or a retraction thereof. Accordingly, the use of a target irradiation assembly in a method for producing pharmaceutical radioisotopes as disclosed hereinabove can provide increased process flexibility and/or shorter downtime of irradiated enclosures, thereby avoiding any logistical and/or safety issues associated with conventional enclosures.

Various aspects of the present disclosure include, but are not limited to, the aspects listed in the following numbered clauses.
Clause 1—An enclosure for producing a radioisotope from an irradiation target material in a thimble guide tube of a nuclear reactor core. The enclosure is comprised of an enriched material. The enclosure defines a cavity therein, wherein the cavity of the enclosure is configured to house the irradiation target material.
Clause 2—The enclosure of clause 1, wherein the enriched material has a short half-life upon being exposed to a neutron flux.
Clause 3—The enclosure of clause 2, wherein the enclosure has a short half-life upon exposure to a neutron flux.
Clause 4—The enclosure of any one of clauses 1-3, wherein the enriched material is isotopically pure.
Clause 5—The enclosure of any one of clauses 1-4, wherein the enriched material comprises a precursor to a beta emitter.
Clause 6—The enclosure of any one of clauses 1-5, wherein the enriched material comprises at least one of Nickel-65, Copper-64, or Copper-66.
Clause 7—The enclosure of any one of clauses 1-6, wherein the enriched material comprises an alloy.
Clause 8—The enclosure of any one of clauses 1-7, wherein the enclosure is comprised of a number of layers.
Clause 9—The enclosure of any one of clauses 1-8, wherein the enclosure comprises an outer wall comprised of the enriched material.
Clause 10—A target assembly for producing synthetic radioisotopes, the target assembly comprising an enclosure defining a cavity therein and an irradiation target material positioned within the cavity of the enclosure. The enclosure is comprised of an enriched material. The irradiation target material comprises a precursor to a first radioisotope.
Clause 11—The target assembly of clause 10, wherein the enriched material comprises a precursor to a second radioisotope, wherein the second radioisotope is a short lived radioisotope.
Clause 12—The target assembly of any one of clauses 10-11, wherein the enriched material comprises an isotopically pure metallic material.
Clause 13—The target assembly of clause 12, wherein the isotopically pure material comprises at least one of Nickel-64, Copper-63, or Copper-65.
Clause 14—The target assembly of any one of clauses 10-13, wherein the enriched material comprises an alloy.
Clause 15—The target assembly of any one of clauses 10-14, wherein a layer of inert material is positioned between the enriched material and the cavity.
Clause 16—A method for producing pharmaceutical radioisotopes with a target assembly, the method comprising inserting the target assembly into a thimble guide tube, irradiating the target assembly with a neutron flux and removing the irradiated target assembly from the thimble guide tube to produce one or more pharmaceutical radioisotopes. The target assembly comprises an enclosure and at least one irradiation target material positioned within the enclosure. The enclosure is comprised of an enriched material.
Clause 17—The method of clause 16, wherein the enriched material comprises Nickel-64, Copper-63, and/or Copper-65.
Clause 18—The method of any one of clauses 16-17, wherein the irradiation target material of the irradiated target assembly comprises Lutetium 177 and/or Actinium-225.
Clause 19—The method of any one of clauses 16-18, wherein each of the irradiation target material and the enclosure of the irradiated target assembly are independently comprised of one or more pharmaceutical radioisotopes.

Various features and characteristics are described in this specification to provide an understanding of the composition, structure, production, function, and/or operation of the present disclosure, which includes the disclosed methods and systems. It is understood that the various features and characteristics of the present disclosure described in this specification can be combined in any suitable manner, regardless of whether such features and characteristics are expressly described in combination in this specification. The Inventors and the Applicant expressly intend such combinations of features and characteristics to be included within the scope of the present disclosure described in this specification. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will not add new matter to the specification or claims and will comply with the written description, sufficiency of description, and added matter requirements.

With respect to the appended claims, those skilled in the art will appreciate that recited operations therein may generally be performed in any order. Also, although various operational flows are presented in a sequence(s), it should be understood that the various operations may be performed in other orders than those that are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. Thus, a method or system that “comprises,” “has,” “includes,” or “contains” a feature or features and/or characteristics possesses the feature or those features and/or characteristics but is not limited to possessing only the feature or those features and/or characteristics. Likewise, an element of a composition, coating, or process that “comprises,” “has,” “includes,” or “contains” the feature or features and/or characteristics possesses the feature or those features and/or characteristics but is not limited to possessing only the feature or those features and/or characteristics and may possess additional features and/or characteristics.

The grammatical articles “a,” “an,” and “the,” as used in this specification, including the claims, are intended to include “at least one” or “one or more” unless otherwise indicated. Thus, the articles are used in this specification to refer to one or more than one (i.e., to “at least one”) of the grammatical objects of the article. By way of example, “a component” means one or more components and, thus, possibly more than one component is contemplated and can be employed or used in an implementation of the described compositions, coatings, and processes. Nevertheless, it is understood that use of the terms “at least one” or “one or more” in some instances, but not others, will not result in any interpretation where failure to use the terms limits objects of the grammatical articles “a,” “an,” and “the” to just one. Further, the use of a singular noun includes the plural, and the use of a plural noun includes the singular, unless the context of the usage requires otherwise.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Also, all ranges recited herein are inclusive of the end points of the recited ranges. For example, a range of “1 to 10” includes the end points 1 and 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

As used in this specification, particularly in connection with layers, the terms “on,” “onto,” “over,” and variants thereof (e.g., “applied over,” “formed over,” “deposited over,” “provided over,” “located over,” and the like) mean applied, formed, deposited, provided, or otherwise located over a surface of a substrate but not necessarily in contact with the surface of the substrate. For example, a layer “applied over” a substrate does not preclude the presence of another layer or other layers of the same or different composition located between the applied layer and the substrate. Likewise, a second layer “applied over” a first layer does not preclude the presence of another layer or other layers of the same or different composition located between the applied second layer and the applied first layer.

Whereas particular examples of this disclosure have been described above for purposes of illustration, it will be evident to those skilled in the art that numerous variations of the details of the present disclosure may be made without departing from the present disclosure as defined in the appended claims.

What is claimed is:

1. An enclosure for producing a radioisotope from an irradiation target material in a thimble guide tube of a nuclear reactor core, wherein the enclosure is comprised of an enriched material, wherein the enclosure defines a cavity therein, and wherein the cavity of the enclosure is configured to house the irradiation target material.

2. The enclosure as claimed in claim 1, wherein the enriched material has a short half-life upon being exposed to a neutron flux.

3. The enclosure as claimed in claim 2, wherein the enclosure has a short half-life upon exposure to a neutron flux.

4. The enclosure as claimed in claim 1, wherein the enriched material is isotopically pure.

5. The enclosure as claimed in claim 4, wherein the enriched material comprises a precursor to a beta emitter.

6. The enclosure as claimed in claim 5, wherein the enriched material comprises at least one of Nickel-64, Copper-63, or Copper-65.

7. The enclosure as claimed in claim 1, wherein the enriched material comprises an alloy.

8. The enclosure as claimed in claim 1, wherein the enclosure is comprised of a number of layers.

9. The enclosure as claimed in claim 1, wherein the enclosure comprises an outer wall comprised of the enriched material.

10. A target assembly for producing synthetic radioisotopes, the target assembly comprising:
an enclosure defining a cavity therein, wherein the enclosure comprises an outer wall comprised of an enriched material; and
an irradiation target material positioned within the cavity of the enclosure, wherein the irradiation target material comprises a precursor to a first radioisotope.

11. The target assembly as claimed in claim 10, wherein the enriched material comprises a precursor to a second radioisotope, wherein the second radioisotope is a short lived radioisotope.

12. The target assembly as claimed in claim 10, wherein the enriched material comprises an isotopically pure metallic material.

13. The target assembly as claimed in claim 12, wherein the isotopically pure metallic material comprises at least one of Nickel-64, Copper-63, or Copper-65.

14. The target assembly as claimed in claim 12, wherein the enriched material comprises an alloy.

15. The target assembly as claimed in claim 10, wherein a layer of inert material is positioned between the enriched material and the cavity.

16. A method for producing pharmaceutical radioisotopes with a target assembly, the method comprising:
inserting the target assembly into a thimble guide tube, the target assembly comprising an enclosure and at least one irradiation target material positioned within the enclosure, wherein the enclosure is comprised of an enriched material;
irradiating the target assembly with a neutron flux; and
removing the irradiated target assembly from the thimble guide tube to produce one or more pharmaceutical radioisotopes.

17. The method as claimed in claim 16, wherein the enriched material comprises Nickel-64, Copper-63, and/or Copper-65.

18. The method as claimed in claim 16, wherein the irradiation target material of the irradiated target assembly comprises Lutetium 177 and/or Actinium-225.

19. The method as claimed in claim 16, wherein each of the irradiation target material and the enclosure of the irradiated target assembly are comprised of a pharmaceutical radioisotope.
